(19) United States
(12) Patent Application Publication
(10) Pub. No.: US 2011/0191810 A1
(43) Pub. Date: Aug. 4, 2011

(54) Method and System for Distribution of Computer and Entertainment Information

(76) Inventors: Christopher L. Thomas, Madison, AL (US); William R. Lazenby, JR., Madison, AL (US); Michael L. Potter, Huntsville, AL (US)

(21) Appl. No.: 12/697,997

(22) Filed: Feb. 1, 2010

(51) Int. Cl. H04N 7/18; G06F 3/01

(52) U.S. Cl. 725/81; 725/78; 715/716

(57) ABSTRACT

Methods and systems provide for the distribution of both computer and home entertainment information. Computer and home entertainment audio-visual sources are distributed to displays throughout a house, and any of the sources can be viewed from any of the displays. Computers and televisions are integrated while allowing the computers and the televisions to be located in separate rooms of the house, thereby minimizing the need to co-locate items or to install additional wiring. The computer and home entertainment sources may be located in a single area and distributed to various receivers throughout the house. Multiple users may share any given information source. The entertainment and computer sources are connected to a single information hub that distributes the various source signals to remote receivers. Users may view any of the sources from any receiver in the house, and multiple different users may view different sources from any receivers in the house.

This generally relates to computer systems and entertainment systems, and more particularly to the distribution of computer and home entertainment information.

### BACKGROUND

For years, the television has been the center of entertainment in the average household. Over the years, televisions have continually improved by providing among other things better picture quality, better sound and larger screens. However, even with the advances in television technology, televisions remain primarily a source to display the programs broadcast by the networks, or other home entertainment audio video components such as DVD players, Digital Video Recorders (DVR), satellite dish receivers, Blu-Ray players, etc.

The advent of personal computers has provided many households with a new addition to their entertainment system, in addition to being a productive addition to the house. The computer can be used for a wide variety of activities ranging from word processing to entertainment to paying bills.

In recent years, many households have sought to combine the entertainment of a television with the flexibility of a computer. By combining the two systems, they are able to enhance the television viewing experience. A computer-television combination makes it possible to create a “smarter” television that allows not only static viewing, but the ability to interact and control the programming.

However, conventional integration of personal computers with television involves an antenna or a video source directly connected to the computer through a cable. In a typical house, the living room includes a cable or antenna connection for the television, and an office or a bedroom includes the personal computer. The computer is usually connected to the Internet or other online services by a modem. Conventionally, if a user wanted to integrate their computer and television, either the computer had to be moved to the living room or the television had to be moved to the office or to the bedroom. Unfortunately, neither of these options is desirable. Most users want their television to remain in the living room, usually a larger room and the gathering place for entertainment. Also, these users do not want to move a desk with the computer into the living room for both aesthetic and practical reasons. Similarly, if the television is moved to the den or another room where a computer might reside, an additional antenna or cable connection must be installed.

In addition, some conventional high definition displays, e.g., flat panel LCD or Plasma TV's, can accommodate multiple input types, such as computer (RGB) and HDTV. However, these systems typically require multiple cables attached to the display, one for each source. It is difficult and sometimes impossible to share a source, such as a computer, by multiple users when the different users are in different rooms. Additionally, conventional systems do not allow computer peripherals controlling a source such as a mouse and keyboard to work via the same connection as that used for the video display.

Conventional systems typically segregate computer and entertainment sources. These systems typically do not have the capability to distribute the source information to multiple rooms simultaneously, forcing the replication of expensive computers, applications and entertainment video sources. Accordingly, there is a desire for methods and systems to address these and other related problems.

### SUMMARY

In accordance with methods and systems consistent with the present invention, a data processing system is provided for distributing computer and home entertainment information, comprising an information hub configured to connect to one or more computer components and one or more audio visual components, receive source information from the one or more computer components and the one or more audio visual components and output the received source information to a distribution network. The distribution network is further configured to receive the source information from the information hub and transmit the source information to one or more receivers. The one or more receivers are further configured to receive the source information from the distribution network. The data processing system further comprises a display connected to one of the receivers configured to display the source information.

In accordance with methods and systems consistent with the present invention, a method is provided in a data processing system for distributing computer and home entertainment information. The method comprises connecting one or more computer components and one or more audio visual components to an information hub, and receiving source information from the one or more computer components and the one or more audio visual components. The method further comprises transmitting the received source information to one or more receivers via a distribution network, and displaying the source information received by the one or more receivers.

In another implementation, a data processing system is provided for distributing computer and home entertainment information. The data processing system comprises an information hub configured to connect to one or more computer components and one or more audio visual components, receive source information from the one or more computer components and the one or more audio visual components, and output the received source information to one or more receivers each connected to a display.

### BRIEF DESCRIPTION OF THE DRAWINGS

FIG. 1 depicts components in a computer and entertainment distribution system in accordance with methods and systems consistent with the present invention.

FIG. 2 illustrates an exemplary information hub in accordance with methods and system consistent with the present invention.

FIG. 3 depicts an exemplary receiver in accordance with methods and systems consistent with the present invention.

FIG. 4 depicts an exemplary method for sending source information from a source to a user in accordance with methods and systems consistent with the present invention.

FIG. 5 depicts an exemplary method for sending user input information from a user to a source in accordance with methods and systems consistent with the present invention.

### DETAILED DESCRIPTION

Methods and systems in accordance with the present invention provide for the distribution of both computer and home entertainment information. The systems distribute computer and home entertainment audio-visual (A/V) sources to displays throughout a house, and any of the sources can be viewed from any of the displays and users may interact with any of the sources from any of the remote locations. They allow users to integrate computers and televisions while allowing the computers and the televisions to be located in separate rooms of the house, thereby minimizing the need to co-locate items or to install additional wiring. In one implementation, the computer and home entertainment sources may be located in single area, e.g., a closet or back room, and distributed to various receivers throughout the house. In this manner, they may also support a single remote location of all computers and home entertainment devices, and sharing of any given information source by multiple users.

The home entertainment sources and the computer sources may be connected to a single information hub that distributes the various source signals to receivers through the house. The information hub also facilitates the distribution of user input to various sources through the house. In this way, users may view or interact with any of the sources from any receiver in the house, and multiple different users may view or interact with different sources from any receivers in the house. Although described with respect to a house, methods and systems in accordance with the present invention may be used in other environments. The information hub may distribute the computer and home entertainment source information throughout the network using a wired or wireless connection to the receivers. The receivers may be connected to a display, e.g., a monitor or television, and optionally a keyboard and mouse for viewing and control of the source information, and speakers for hearing audio content. In one implementation, supporting all of the different types of sources, the single distribution network distributes the various different types of computer and home A/V source information.

The system also provides support for high resolution computer and entertainment video on the same system, and may allow a viewer to receive information from multiple sources, such as a picture-in-picture (PIP) or picture-by-picture (PBP) view of a DVD player window in or next to a window for a computer application. The system also provides support for receiving information from a user via keyboard, mouse, microphone, USB input or any other suitable input. USB components may include video cameras, printers, USB drives, CD drives, DVD or BluRay drives, tablets, or any other component.

The system includes an information hub, to which each source of computer and entertainment information is attached, a distribution system for the transmission of selected source information to the appropriate user destination, receivers for receiving the source information from the information hub via the distribution system, and a user interface for convenient control of the system typically viewed on a screen attached to the receivers. The receivers also receive input information from a user such as keyboard, mouse, microphone and USB and transmit it to the information hub. Any of these components may be hardware and/or software or any combination of hardware and software. These systems address previously mentioned problems by aggregating and distributing many different types of sources to various displays, inputs and speakers.

For example, a DVD player, DVR, two computers, a CD player, a satellite dish receiver, and a cable television box may be connected to the information hub. One user may be able to access a monitor, keyboard and mouse to remotely watch the live cable television in one window, while simultaneously operating one of the computers in another window. Another user in a different room may operate a different computer while simultaneously viewing the DVD player in a picture-in-picture mode. Yet a third user may watch the DVR on a television screen connected to a receiver in a different room, and a fourth user in a different location may watch the same DVR. Any various combinations of users, remote locations, and source components may be used, and any of the displays and speakers may be used to display or output any of the sources. The user controls connected to a given receiver control the source being viewed and outputted on the display and speakers connected to that receiver.

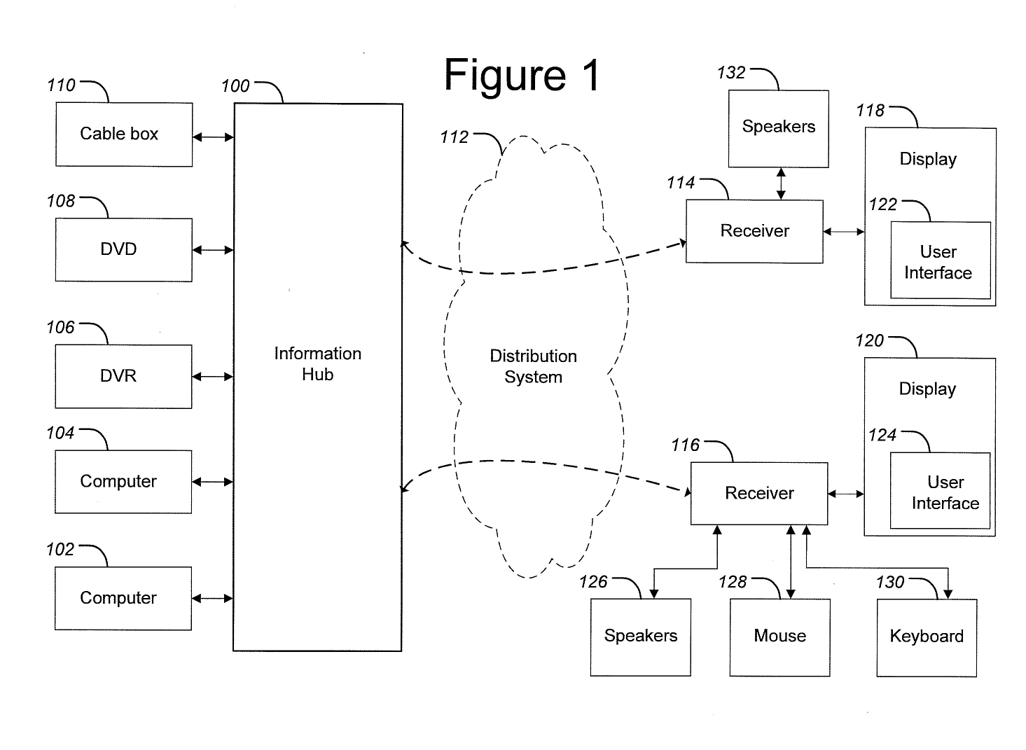

FIG. 1 depicts components in a computer and entertainment distribution system in accordance with methods and systems consistent with the present invention. On the figure, several computer and home entertainment sources are plugged into the information hub 100, such as computer 102, computer 104, a DVR 106, a DVD player 108 and a cable box 110. Many other source components may be used, and many other types of source components may be used.

The information hub 100 may accept any computer source input including, but are not limited to, keyboard, mouse, USB, serial, parallel, fire wire, audio, mass storage and video including RGB, DVI or any other suitable component or media. The information hub 100 also accepts any entertainment audio visual component inputs including, but not limited to, audio, serial, IR and video, whether analog or digital, including NTSC, PAL or SECAM RF modulation methods, component, composite, S-video, HDMI, DVI, VGA, RF coaxial, fiber optic or other any other suitable component or media. The information hub 100 accepts audio including line level, microphone, RCA Preamp (Left/Right), RCA Preamp (PCM), and TOSLINK (Fiber Optic) and any other suitable inputs.

In addition to accepting the computer and entertainment inputs, the information hub 100 serves various functions including video and audio processing. Video processing includes, for example, conversion of any video source to a common digital format, image scaling if necessary, and switching of a selected source so that it can be presented by the distribution system for viewing. This processing also includes switching, converting the information to packets and preparing the information for transmission over the distribution system 112. It also includes generation of on-screen menus, windowing of multiple sources onto a single screen and compression of the video information for efficient transmission by the distribution system 112. For audio processing, the information hub 100 processes the audio content from any selected source, e.g., through an analog-to-digital conversion, switches, converts it to packets and prepares it for transmission over the distribution system 112. The audio may also be scaled up or down, e.g., from stereo to 7.1 surround sound.

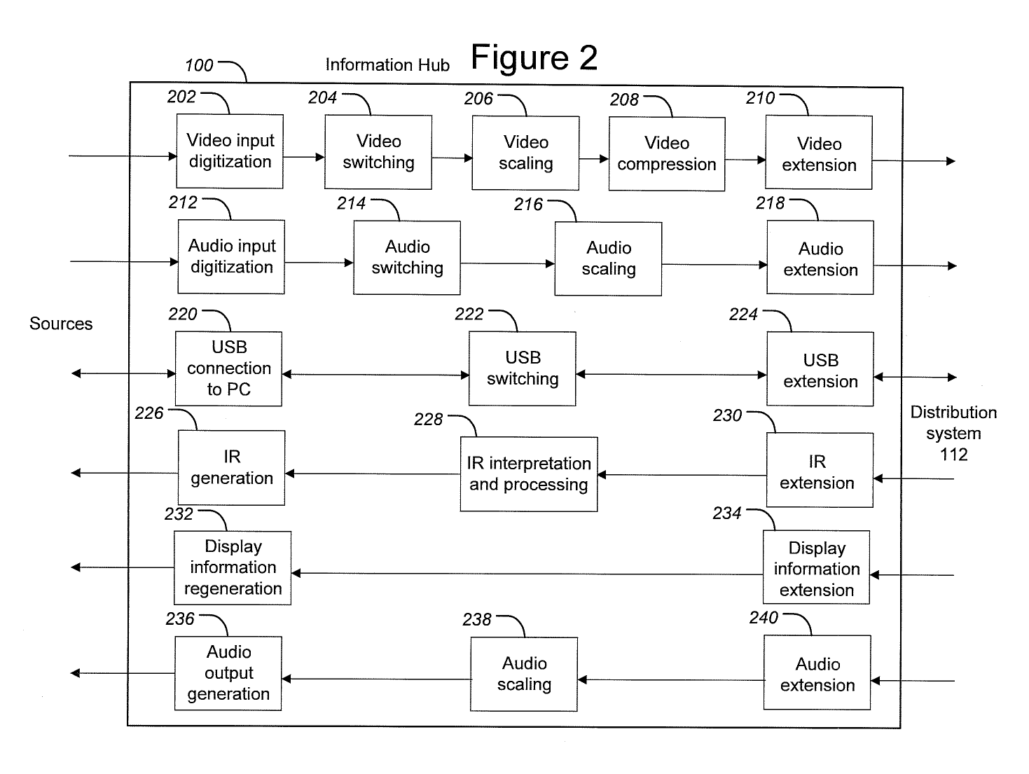

Furthermore, the information hub 100 performs other processing and receives mouse, keyboard and USB signals from the receivers 114-116 and relays those signals to the corresponding source for control of the source, e.g., computer 104. These signals may be received as a result of the user operating a user interface 122 described below. Additional details of the information hub 100 are discussed further with respect to FIG. 2.

The information hub 100 passes the source information to the receivers 114-116 through the distribution system 112. It also receives control signals from the users via the receivers 114-116. The distribution system 112 may be a wired or wireless network. In a wired network, for example, the source components may be connected to the information hub 100 with any type of cable, such as CAT-5 cables, for example. In the case of a wireless network, any wireless network may be used. In one implementation, an Ethernet connection is used to transmit the selected source information to a user destination. In one implementation, the distribution system 112 uses lossless, low latency, high resolution Dambrackas Video Compression (DVC) to transmit video source information across the distribution system. The DVC compression provides high resolution while providing low latency so that users may have a low mouse lag time when operating the user interface.

At each user destination, a receiver 114-116 accepts, for example, Ethernet or wireless communication packets of compressed video and other information and reconstitutes the video image for presentation to the user. The distribution system 112 permits a broadcast capability whereby the same information can be sent simultaneously to multiple receivers 114-116 and users. Also, the distribution system 112 allows different source information to be sent simultaneously to different users.

A receiver 114 may be a hardware component that connects to the distribution system 112 to receive source information from the sources, and to relay control information received through the user interface from a user to control the source component. A receiver 114-116 may be connected to a display 118-120 (such as a monitor or television), speakers 126, 132, USB or other outputs for the user. It may also be connected to a mouse 128, keyboard 130, remote control (not shown) or other inputs for the user to control the user interface 122-124. The receiver 114 may also have USB inputs to connect to various USB devices, and may also have an input for a remote control, such as an infrared (IR) or RF wireless input. A receiver 114 may also have, for example, inputs for a CAT-5 cable from the distribution system 112, as well as inputs for the displays 118-120, speakers 126, 132 televisions, mouse 128, keyboard 130 and microphone as well as any other suitable components.

There may be receivers 114-116 connected to displays (e.g., monitors, televisions) and/or speakers throughout a house. Different receivers 114-116 may receive the same source information at the same time, and any receiver 114 may view multiple sources simultaneously. In one implementation, a receiver 114 may be an HMX 1050 user station from Avocent Inc., or a similar device.

Users activate and interact with the sources through the user interface 122 provided by the receiver 114 to the monitor. The user interface 122-124 provides an on-screen interface for the user to control a source, such as a computer 102, DVD player 108 or stereo. In addition, the user interface 122-124 may provide features such as picture-in-picture and picture-by-picture, and can display multiple sources on the same screen. For example, a user may operate the user interface 122-124 to watch cable television content while simultaneously viewing the output from the DVD player 108. It may also provide the capability for a user to start viewing a movie, for example, in the living room, pause it and continue viewing it in a different room. It may also similarly control audio sources played through the speakers or USB.

In addition, the user interface 122-124 provides on-screen menus and supports functions including source selection, screen layout, security features, menu look-and-feel, remote control settings, PIP and PBP configuration and system configuration. The user interface 122-124 controls switching behavior, sets up the system for various sources and acts as a control center system for the system, and manages how multiple sources are watched at one time. Specifically, the user interface 122-124 may activate PIP or PBP modes, swap the primary and secondary content source, change the location, size, and layout of the PIP/PBP windows. The user interface 122-124 generates on-screen graphics and may also interpret infrared remote control signals. The user interface 122-124 can be operated by keyboard 130, mouse 128, or infrared remote or any other suitable input.

The user interface 122-124 may also display icons representing different sources for the user to select. Icons may also represent the different rooms, so that a user could watch whatever was being watched in a given room. This allows a person, for example, to stop watching a show in the living room and start watching it in the bedroom, by selecting the living room icon when the user gets to the bedroom.

In an additional feature, the user interface 122-124 may provide parental controls such as the ability to view and/or listen to the output of a receiver 114 (e.g., child's display) from a different receiver 116 (e.g., parent's display). In this implementation, various permissions may be set up to control which receivers 114-116 may be monitored or controlled from a different receiver. The room selection icons may be used to view a child's room.

A user interface 122-124 may be an on screen display in one implementation, but may also be any other suitable device a user might use to convey control information to the receiver 114, the Information hub 100, the A/V sources, or a computer source. This may include, but is not limited to, a mouse, a keyboard, an IR remote control, an RF remote control, a game controller, as well as buttons, displays, or touch-screens on the receiver 114 or information hub 100.

Since this system merges computers and A/V equipment, traditional computing devices may also control the user interface 122. A special keyboard key sequence may access the on screen display enabling control via a keyboard or mouse. This interface allows for a virtual remote control to be used, so that the function of the regular remote control can be performed via the keyboard and mouse interface.

Receivers 114-116 receive and decompress DVC protocol video signals which provide the ability to view video while minimizing mouse lag time. Furthermore, video scaling may be performed by the receiver 114-116. For example, a 1080i video signal may be sent across the distribution system 112 to the receiver 114-116, and the receiver may upscale it to 1080p or downscale it to 480p, for example, depending on the attached display 118-120. Image scaling may also be performed by the information hub 100.

The receivers 114-116 may also receive audio data and USB signals as well from the information hub 100. They may output these through attached speakers and/or USB components. In addition, the receivers 114-116 may also receive audio, keyboard, mouse, USB, IR and RF inputs from the user and transmit them to the information hub 100 to be relayed to components attached to the information hub 100. The USB information may travel in either direction, from source component to a user device, or from a user device to a source component. The receivers 114-116 may also receive display information from the display, such as the capabilities of the display so that the system may scale and process the video appropriately.

FIG. 2 illustrates an exemplary information hub 100 in accordance with methods and system consistent with the present invention. The information hub 100 accepts inputs from the sources and may receive various types of inputs such as USB, serial, parallel, USB, DVI, HDMI, RGB, component inputs, any other previously discussed inputs, and any other input from a computer or entertainment component.

In the Figure, the information hub 100 includes various components for the flow of video information from source components to the receivers 114-116 and ultimately the user, i.e., video input digitization component 202, video switching component 204, video scaling component 206, video compression component 208, and video extension component 210. It similarly includes components for the flow of audio information from the sources to the receivers 114-116 and ultimately the user, i.e., audio input digitization component 212, audio switching component 214, audio scaling component 216, and audio extension component 218. Along these lines, the information hub 100 also includes components for transmitting USB information to the receiver 114-116 from the sources and receiving USB information from the receiver, including USB connection to PC component 220, USB switching component 222, and USB extension component 224. These various components may be hardware, software or a combination of both and are described further below.

In the reverse direction from the user to the receiver 114 and then the information hub 100 and sources, several other components are shown, including IR extension component 230, IR interpretation and processing component 228, and IR generation component 226 for transmitting infrared signals from the receiver 114 to source components. Also, display information is transmitted through display information extension component 234 and display information regeneration component 232. For audio traveling in the reverse direction, the information hub 100 includes audio extension component 240, audio scaling component 238 and audio output generation 236.

For video and audio information going from a source through the information hub 100 to a receiver 114 and then to a user, video input digitization component 202 and audio input digitization component 212 receive input from the audio and video sources connected to the information hub 100, and output digital video and audio streams. Video and audio signals coming from an information source are captured and stored into a digital format allowing them to be easily analyzed and/or compressed downstream. There are many different forms for video and audio signals, and, in one implementation, video input digitization component 202 and audio input digitization component 212 harmonize these possibilities into a uniform format for the video switching component 204 and audio switching component 214. Similarly, the USB connection to PC component 220 connects the PC's USB input to the information hub 100.

Typically, DVD players and Blu-Ray players use High-Defmition Content Protection (HDCP) to prevent digital copying of raw high-definition audio/visual content by encoding the information. In order to extend such a source, the Information hub 100 may be HDCP compliant (e.g., emulating a television). The video input digitization component 202 may include HDCP protocol support and decryption. Distributing the data in raw digital form may be a violation of HDCP, so the video extension component 210 insures the network data includes sufficient network encryption. On the receiver 114, the corresponding video extension component 302 supports the decryption of the network data, and the video output generation component 308 may be an HDCP content source (e.g., emulating a DVD player).

The video switching component 204, audio switching component 214 and USB switching component 220 accept these digital data streams and inputs and route them from any possible source's input digitization data to any output. Switching involves routing of a source to a particular destination, e.g., computer A to receiver B and computer B to receiver A, switching the paths of one to another. Video compression component 208 may be used to compress the video in any suitable compression format, such as the DVC compression format, before being transmitted by the video extension component 210 to the receiver 114.

The video scaling components 206 and audio scaling components 216, 238 may change a signal from one resolution to another, e.g., a video image of 1080i to 480p. Scaling may optionally be done at the information hub 100, or may occur on the receivers 114-116. Scaling on the receivers 114-116 may be preferable because, for example, if two users watched the same movie and one is watching on a TV that displays 1080i and the other is watching on a computer that displays 720p, if the scaling occurs on the information hub 100, two unique sets of information need to be compressed and extended across the network. If scaled at the receiver 114, however, the larger version, e.g., 1080i, may be scaled and extended alone. In this case, the first receiver 114 would not need to scale, while the second 116 would scale the data from 1080i to 720p. In short, receiver scaling may reduce network traffic. The trade-off may be design complexity in the receivers 114-116 versus the information hub 100. Potential users and customers may be more willing to acquire a more complex information hub 100 than many complex receivers.

The extension components 210, 218, 224, 230, 234, and 240 are used to transmit and receive the signals between the information hub 100 and the receivers 114-116 over the distribution system 112. The video extension component 210, audio extension component 218, and USB extension component 224 are extension transmitters, while the IR extension component 230, display information extension component 234, USB extension 224 and audio extension component 240 are extension receivers. The receivers 114-116 also have corresponding extension receivers (to receive signals from the information hub extension transmitters) and extension transmitters (to send signals to the information hub extension receivers).

The extension transmitters, video extension component 210, audio extension component 218, and USB extension component 224, send video, audio and USB data to the receivers 114-116. They receive a digital data stream from the switching components 204, 214, 222 and/or scaling components 206, 216 and/or compression component 208 and output network packets. They organize the digital data stream into network packets, insuring data gets to its intended destination successfully. They also handle any signal conversion or protocol requirements. In the case of a Gigabit Ethernet, this includes a TCP/IP or UDP/IP network engine, as well as conversion to Gigabit Ethernet electrical signals.

The extension component receivers 230, 234, 240 receive network packets and output a digital data stream. They reconstitute the original data stream from the network packets. They also handle any signal conversion or protocol requirements.

The IR interpretation and processing component 228 examines user IR instructions, and in some cases, the information is destined for the source attached to the information hub 100, and it is relayed there through the IR generation component 226 which sends the IR information out. In other cases, the IR information might be intended to control the information hub 100 or receiver 114, so it is interpreted and then the appropriate system response is effected. The IR remote control may be an RF remote control, and the IR information signals may also be RF remote control information signals (not shown on the Figure).

Display information is received from the display information extension receiver 234 and is transmitted to the source from the information hub 100 via display information regeneration component 232.

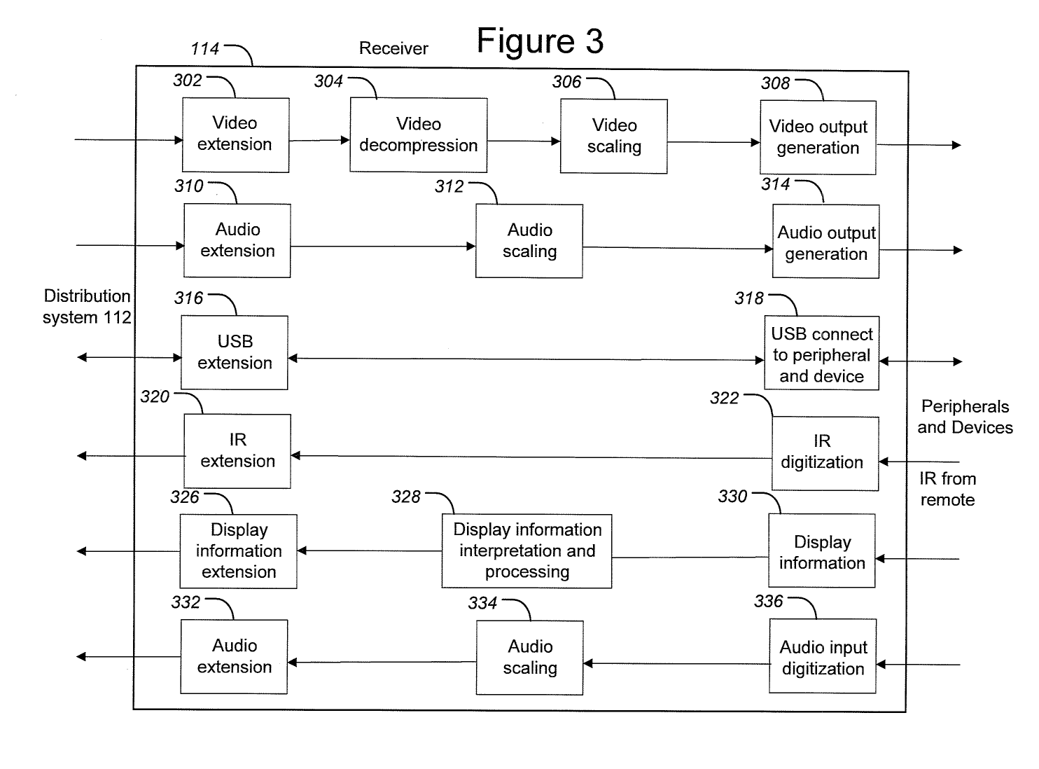

FIG. 3 depicts an exemplary receiver 114 in accordance with methods and systems consistent with the present invention. For video audio and USB data going from the information hub 100 to the receiver 114, the video, audio and USB is received in the video extension component 302, audio extension component 310, and USB extension component 316 from the corresponding extension components in the information hub 100 as shown on FIG. 2.

Video is decompressed in video decompression component 304, and may be scaled in video scaling component 306 before being outputted by output generation component 308 to a display device. Audio may similarly be scaled by audio scaling component 312 before being outputted by audio output generation component 314. The USB connection to the peripherals and device component 318 is used to connect USB signals to an external device from the USB extension component 316.

In the reverse direction from the user through the receiver 114 to the information hub 100, the audio input digitization component 336 receives audio from an audio input device such as a microphone, digitizes it and sends it to the audio scaling component 334 which potentially scales the audio before sending it to the audio extension component 332 for transmission to the information hub 100.

The IR digitization component 322 receives an infrared signal from the remote control and digitizes the signal. The digitized signal is then sent to the IR extension component 320 to be transmitted to the information hub 100.

In the case of display information, the receiver 114 reads information stored in the display to discern the capabilities of the display. The display information is used by the system to make decisions about scaling and video modes. This information is interpreted and processed by the display information interpretation and processing component 328 before being transmitted to the display information extension component 326 for transmission to the information hub 100.

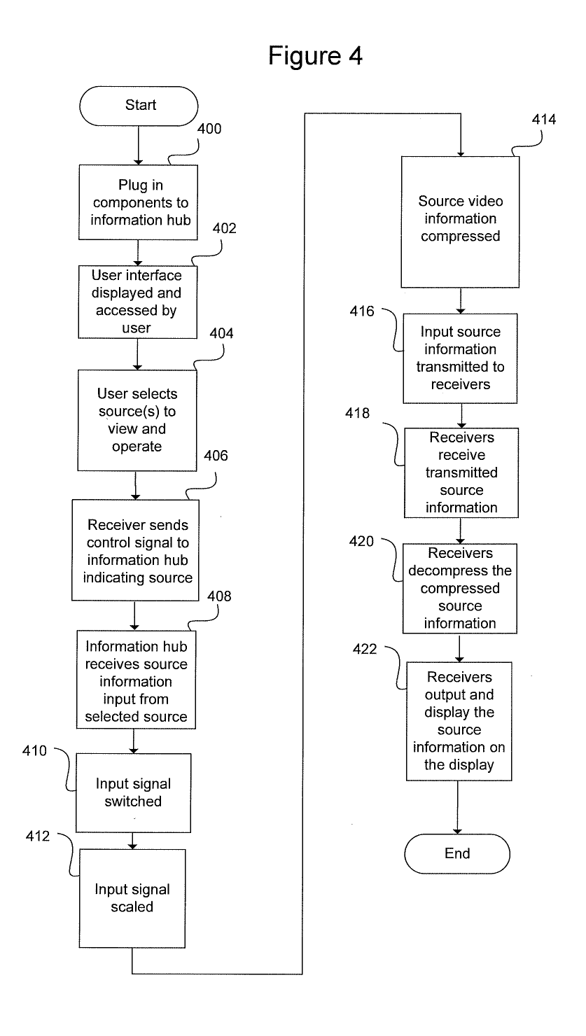

FIG. 4 depicts an exemplary method for sending source information from a source to a user in accordance with methods and systems consistent with the present invention. First, the sources are plugged into the information hub 100 (step 400). The information hub 100 may be, for example, in a closet or back room out of view which may also store the computer and entertainment sources. In one implementation, these sources may connect to the information hub 100 wirelessly. The receivers 114-116 are connected to displays, such as monitors and televisions, in the house. They are also connected to speakers 126, keyboards 130, mouse 128 and USB devices (not shown) where appropriate. The user accesses the user interface 122-124 provided by the receiver 114 and displayed on the monitor (step 402). On the user interface 122, the user may select one or more sources to view and/or operate (step 404).

Upon selection of a source, the receiver 114 sends a control signal over the distribution system 112 to the information hub 100 indicating the source to be activated (step 406). The source information on the appropriate input is selected, and the source information is accepted through the appropriate input 202, 212, 220 of the information hub 100 (step 408). It is then switched by the switching components 204, 214, 222 (step 410) and optionally scaled by video and audio scaling components 206, 216 (step 412). In one implementation, the information hub 100 may scale the video, and in another implementation, the receiver 114 scales the video to be accepted by the display 118 attached to the receiver. The video compression component 208 compresses the source video information, for example, using the DVC protocol (step 414). The switched, scaled and/or compressed source information and is transmitted to the receiver 114 (step 416). The receiver 114 then receives the source information (step 418) and decompresses the source information (step 420). The receiver 114 then outputs the decompressed and processed information to the monitor for viewing by the user (step 422).

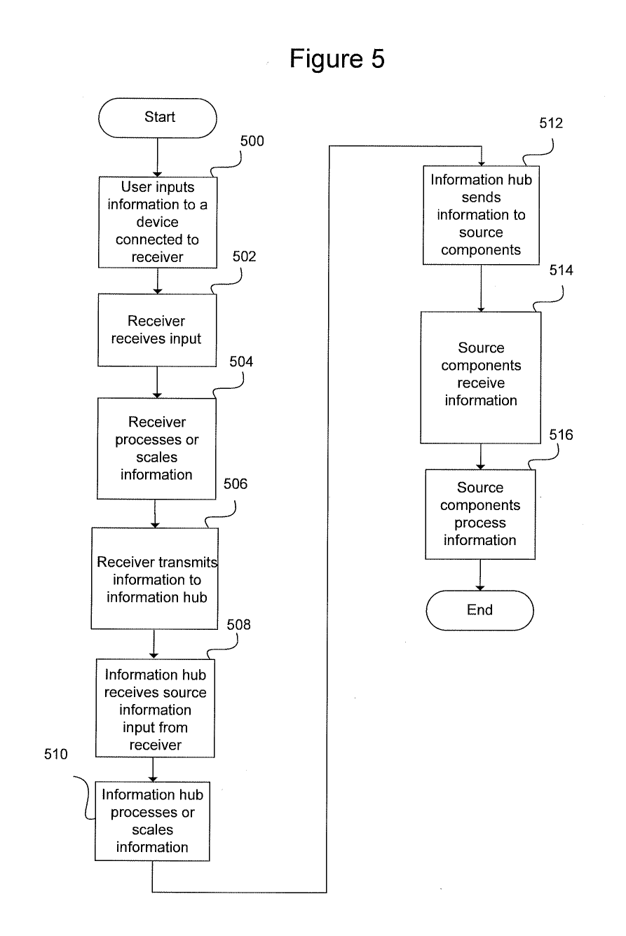

FIG. 5 depicts an exemplary method for sending user input information from a user to a source in accordance with methods and systems consistent with the present invention. First, the user inputs information to a device connected to the receiver 114 (step 500). This may be any input such as microphone, a USB device, keyboard or mouse input. The receiver 114 receives this input at the USB, IR, display and audio input components 318, 322, 330, 336 (step 502). The receiver 114 then processes or scales the information with components 328, 334 (step 504). The receiver 114 then transmits the information to the information hub 100 via the USB, IR, display information and audio extension components 316, 320, 326, 332 (step 506).

The information hub 100 receives a source information input from the receiver 114 at its extension components 224, 230, 234, 240 (step 508). The information hub 100 processes or scales the received information (step 510). The information hub 100 then sends the information to the source components via the output generation components 220, 226, 232, 236 (step 512). The source components receive the information (step 514), and then utilize the information (step 516).

The foregoing description of exemplary embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A data processing system for distributing computer and home entertainment information, comprising:
an information hub configured to:
connect to one or more computer components and one or more audio visual components;
receive source information from the one or more computer components and the one or more audio visual components; and
output the received source information to a distribution network;
the distribution network configured to receive the source information from the information hub and transmit the source information to one or more receivers;
the one or more receivers configured to receive the source information from the distribution network; and
a display connected to one of the receivers configured to display the source information.

2. The data processing system of claim 1, wherein the one or more receivers are configured to receiver user input information and transmit the received user input information to the information hub; and
wherein the information hub is further configured to receiver the user input information transmitted from the one or more receivers and transmit the receiver user input information to the one or more audio visual components.

3. The data processing system of claim 1, further comprising a user interface configured to permit the user to select one or more of the computer components and one or more of the audio visual components for viewing.

4. The data processing system of claim 3, wherein the one or more receivers are configured to connect to the display, a mouse and a keyboard.

5. The data processing system of claim 4, wherein the one or more receivers are configured to connect to one of (1) speakers and (2) a home entertainment audio receiver.

6. The data processing system of claim 1, wherein video source information in the source information is compressed using the DVC protocol.

7. The data processing system of claim 6, wherein the one or more receivers decompress the received video source information using the DVC protocol.

8. The data processing system of claim 1, wherein the distribution network is a wired network.

9. The data processing system of claim 1, wherein the distribution network is a wireless network.

10. The data processing system of claim 1, wherein the audio visual components comprise one of: (1) a DVD player, (2) a cable receiver, (3) a satellite receiver, (4) a DVR, (5) a stereo, (6) a CD player and (7) a Blu-Ray player.

11. The data processing system of claim 1, wherein the information hub has inputs accepting one or more of USB, serial, parallel, fire wire, RGB, DVI, HDMI, component video, composite video, S-video, VGA, RF coaxial, and fiber optic, and line level audio.

12. A method in a data processing system for distributing computer and home entertainment information, comprising:
connecting one or more computer components and one or more audio visual components to an information hub;
receiving source information from the one or more computer components and the one or more audio visual components; and
transmitting the received source information to one or more receivers via a distribution network; and
displaying the source information received by the one or more receivers.

13. The method of claim 12, further comprising:
receiving user input information by the one or more receivers and transmitting the received user input information to the information hub; and
receiving, by the information hub, the user input information transmitted from the one or more receivers and transmitting the received user input information to the one or more audio visual components.

14. The method of claim 12, further comprising displaying a user interface to permit the user to select one or more of the computer components and one or more of the audio visual components for viewing.

15. The method of claim 14, connecting the one or more receivers to the display, a mouse and a keyboard.

16. The method of claim 15, connecting the one or more receivers to one of:
(1) speakers and (2) a home entertainment audio receiver.

17. The method of claim 12, compressing video source information in the source information using the DVC protocol.

18. The method of claim 17, decompressing the received video source information using the DVC protocol.

19. The method of claim 12, wherein the received source information is transmitted to one or more receivers over a wired network.

20. The method of claim 12, wherein the received source information is transmitted to one or more receivers wirelessly.

21. The method of claim 12, wherein the audio visual components comprise one of: (1) a DVD player, (2) a cable receiver, (3) a satellite receiver, (4) a DVR, (5) a stereo, (6) a CD player and (7) a Blu-Ray player.

22. The method of claim 12, wherein the information hub has inputs accepting one or more of USB, serial, parallel, fire wire, RGB, DVI, HDMI, component video, composite video, S-video, VGA, RF coaxial, and fiber optic, and line level audio.

23. A data processing system for distributing computer and home entertainment information, comprising:
an information hub configured to:
connect to one or more computer components and one or more audio visual components;
receive source information from the one or more computer components and the one or more audio visual components; and
output the received source information to one or more receivers each connected to a display.
